(19) United States
(12) Patent Application Publication
(10) Pub. No.: US 2024/0229775 A1
(43) Pub. Date: Jul. 11, 2024

(54) LOAD-DRIVEN ENERGY SYSTEM

(71) Applicants: Mustaqim Ahmed Akhlaque Ahmed Ansari, Thane (IN); Akhlaque Ahmed Zahir Ahmed Ansari, Thane (IN)

(72) Inventors: Mustaqim Ahmed Akhlaque Ahmed Ansari, Thane (IN); Akhlaque Ahmed Zahir Ahmed Ansari, Thane (IN)

(21) Appl. No.: 18/595,404

(22) Filed: Mar. 4, 2024

Related U.S. Application Data
(63) Continuation of application No. PCT/IN2022/050786, filed on Sep. 2, 2022.

(30) Foreign Application Priority Data
Sep. 4, 2021 (IN) 202121040148

(51) Int. Cl. F03G 3/00

(52) U.S. Cl. CPC F03G 3/087

(57) ABSTRACT

A load-driven energy system comprising: a motor (12) to input motor power; an input drive to transfer input power; a load bearing drive, with loads (50), to receive said input power, at a driver end (18c), to transfer to drive said loads (50) across said load bearing drive having a downward slope from its said driver end (18c) to its driven end (18d), said loads (50) sliding down said load bearing drive with: a first force assisted with rails (52a), said first force being gravity-fed force caused due to said downward slope; a second force provided by a load supporting drive; output of said loads bearing drive being load bearing force caused by the summation of said first force and said second force; an output drive connected to said driven end (18d) to provide said load bearing force to an alternator (60) configured to output load-driven power.

### RELATED APPLICATIONS

This application claims priority under 35 U.S.C. § 120 to, and is a continuation of, co-pending International Application PCT/IN2022/050786, filed Sep. 2, 2022 and designating the US, which claims priority to IN Application 202121040148, filed Sep. 4, 2021, such IN Application also being claimed priority to under 35 U.S.C. § 119. These IN and International applications are incorporated by reference herein in their entireties.

### FIELD

This invention relates to the field of mechanical engineering. Particularly, this invention relates to the field of load-driven energy system.

### BACKGROUND

Energy can be transformed from one form to another.

There is a need for a system which infuses kinetic energy, with some impetus from electric energy, and uses them, both, to generate output power.

### SUMMARY

An object of the invention is to harness energy efficiently.

According to this invention, there is provided a load-driven energy system. comprising:
a motor configured to input motor power;
an input drive configured to transfer said input motor power to further drives, said transferred input power being input drive power;
a load bearing drive, configured with loads, in order to receive said input drive power, at a driver end, to transfer to drive said loads across said load bearing drive, said load bearing drive having a downward slope from its said driver end to its driven end, said loads sliding down said load bearing drive with:
a first force assisted with rails running laterally spaced apart from said load bearing drive, said first force being gravity-fed force caused due to said downward slope;
a second force provided by a load supporting drive provided further to said load bearing drive;
output of said loads bearing drive being load bearing force caused by the summation of said first force and said second force;
said load supporting drive configure to receive said input drive power in order to drive a shaft, bearing second loads located at its distal driven end, through its driver end point connected to said load bearing drive by means of a cam which converts angular displacement caused by said input drive power to linear displacement of said shaft, said cam-based load displacement causing generation of said second force to be given to said load supporting drive; and
an output drive connected to said driven end of said load bearing drive in order to provide said load bearing force to an alternator configured to output load-driven power.

In at least an embodiment,
said input drive comprising:
a first drive, from said motor, configured to angularly displace a first angularly displaceable shaft;
a first toothed wheel located on a second angularly displaceable shaft, said second angularly displaceable shaft being transverse to said first angularly displaceable shaft;
a second drive, from a second toothed wheel coupled to said first toothed wheel by means of a second drive, said second toothed wheel located on a third angularly displaceable shaft, said third angularly displaceable shaft being laterally spaced apart from said second angularly displaceable shaft;
a third toothed wheel being located on said third angularly displaceable shaft;
a fourth toothed wheel connected to said third toothed wheel by means of a third drive, in that, radius of said fourth toothed wheel always being greater than radius of said third toothed wheel so as to cause a downward slope of said second drive from said third toothed wheel to said fourth toothed wheel in order to harness gravity-fed kinetic energy of loads on the said third drive; and
a fifth toothed wheel located on said third angularly displaceable shaft;
said load bearing drive comprising:
a plurality of loads installed on said third drive, in that,
number of said loads being correlative to teeth of said third toothed wheel and adjusted according to said fourth toothed wheel;
number of said loads being correlative to slope achieved between said third toothed wheel and said fourth toothed wheel;
a sixth toothed wheel coupled to said fifth toothed wheel by means of a fourth drive;
said load supporting drive comprising:
a fourth angularly displaceable shaft configured to host said sixth toothed wheel, in that.
a distal end, of said fourth angularly displaceable shaft, is fixed while a proximal end, of said fourth angularly displaceable shaft, is connected to an L-shaped lever, said distal end of said L-shaped lever being connected to a fifth angularly displaceable shaft; a short arm of said L-shaped lever being co-axial with said fourth angularly displaceable shaft and a long arm of said L-shaped lever extending away and upwards from said short arm and being orthogonal to said fourth angularly displaceable shaft;
a slide bearing provided at a point, on said fifth angularly displaceable shaft, such that it ensconces said sixth shaft circumferentially through a hole in said slide bearing;
said output drive comprising
a sixth angularly displaceable shaft with a fixed end extends from an operative bottom of said slide bearing such its threadings forms a coupling between a threaded shaft and said slide bearing;
a seventh toothed wheel is connected by a fourth drive to an eighth toothed wheel; and
an eighth toothed wheel located, axially, about a seventh angularly displaceable shaft from which output is derived.

In at least an embodiment, said first drive being a belt drive configured to drive a communicably coupled first belt wheel which is coupled to a spaced apart worm and worm wheel by means of said first angularly displaceable first shaft; said first belt wheel, said worm, and said worm wheel being synchronously angularly displaceable in relation to output of said motor.

In at least an embodiment, said first toothed wheel connected, by means of a said second drive being a first chain drive, to a second toothed wheel, located on said third shaft, said third shaft being spaced apart from said second shaft, the first toothed wheel being a free wheel ensuring that it moves in a single direction only.

In at least an embodiment, said first toothed wheel is the same diameter as the second toothed wheel.

In at least an embodiment, said second toothed wheel is located, axially, on said angularly displaceable third shaft and said third toothed wheel is located on same said angularly displaceable third shaft.

In at least an embodiment, on said third angularly displaceable shaft, said fifth toothed wheel is located such that said second toothed wheel and said fifth toothed wheel are on either side of said third toothed wheel, said second toothed wheel, said fifth toothed wheel, and said third toothed wheel are all co-axially located about said third angularly displaceable shaft.

In at least an embodiment, said third angularly displaceable shaft connects said third toothed wheel to said fifth toothed wheel, said second toothed wheel, said fifth toothed wheel, said third toothed wheel, and said third shaft being synchronously angularly displaceable.

In at least an embodiment, said fourth toothed wheel is connected to the third toothed wheel by means of said second drive.

In at least an embodiment, said fourth toothed wheel having a specific correlation with said third toothed wheel in terms of number of teeth/diameters/radii/size, in that, ratio of said fourth toothed wheel to said third toothed wheel, in terms of number of teeth/diameters/radii/size, is selected from a group of ratios consisting of 1:2, 1:3, 1:4, 1:5.

In at least an embodiment, said loads being provided pre-defined spaced apart intervals according to teeth of said third toothed wheel on said third drive.

In at least an embodiment, said loads deriving support from rails running laterally spaced apart from said third drive, on either side of said second drive.

In at least an embodiment, half the number of teeth on said third toothed wheel equals distance between two consecutive loads.

In at least an embodiment, ratio, in terms of number of teeth/diameters/radii/size between said fifth toothed wheel and said sixth toothed wheel is 1:1.

In at least an embodiment,
said L-shaped lever forming a cam such that angular displacement of said sixth toothed wheel causes said proximal end, of said fourth angularly displaceable shaft, to be angularly displaced, in a first direction, only up to a first end point before reversing the direction to cause angular displacement, in a second direction, only up to a second end point, and so on and so forth, to form a rocking angular displacement motion, in a roll degree of freedom of a first plane, of a short arm of the L-shaped lever;
said long arm of said L-shaped lever, causes rocking itself in terms of angular displacement, in a yaw degree of freedom of a second plane, orthogonal to said first plane, said rocking angular displacement causes said fifth shaft to be linearly displaceable about is length-wise axis; due to said cam action provisioned by said L-shaped lever.

In at least an embodiment, said angular displacement, of the L-shaped lever, traverses 240 degrees which is 30 degrees beyond its highest point and 30 degrees beyond its lowest point, said extra traversal of 30 degrees, in either direction, provides extra force required to ride up said loads from their nadir point (at their point of engagement with the third toothed wheel) to their zenith point (at their point of disengagement with the third toothed wheel).

In at least an embodiment, said fifth angularly displaceable shaft has a proximal end which connects to said L-shaped lever and a distal end consisting essentially of an auxiliary load.

In at least an embodiment, a sixth angularly displaceable shaft with a fixed end extends from an operative bottom of said slide bearing such that threadings, of said threaded sixth angularly displaceable shaft forms a coupling between said sixth threaded shaft and said slide bearing.

In at least an embodiment, said fourth toothed wheel is located, axially, about said sixth angularly displaceable shaft.

In at least an embodiment, said output generator is coupled to said seventh shaft by means of a belt drive.

In at least an embodiment, said input drive's shaft is the same as said output drive's shaft.

### BRIEF DESCRIPTION OF THE ACCOMPANYING DRAWINGS

The invention will now be described in relation to the accompanying drawings, in which:

FIGS. 1, 2, 3, and 4 illustrate various schematic drawings of the system of this invention. FIG. 3A illustrates a complete working embodiment;

FIGS. 5A and 5B illustrate a schematic drawing of a load and a load bracket associated with the load;

FIG. 5C illustrates a schematic drawing of another type of the same load;

FIGS. 5D and 5E illustrate a schematic drawing of another type of the same load;

FIG. 6 illustrates a schematic drawing of loads on the second chain drive;

FIG. 7 illustrates another schematic drawing of loads on the second chain drive;

FIG. 8 illustrates another schematic drawing, depicting an alternative version, of the entire system. FIG. 8A illustrates a complete working embodiment;

FIGS. 9A, 9B, 9C, and 9D show various positions of the L-shaped lever along with corresponding location of loads (50) and corresponding location of auxiliary load;

FIGS. 10, 11, 12, and 13 illustrate the system of this invention in relation to rpm of drives at various nodes in the system; and

FIG. 14 illustrates how slope increases as ratio of driver end to driven end increases.

### DETAILED DESCRIPTION

According to this invention, there is provided a load-driven energy system.

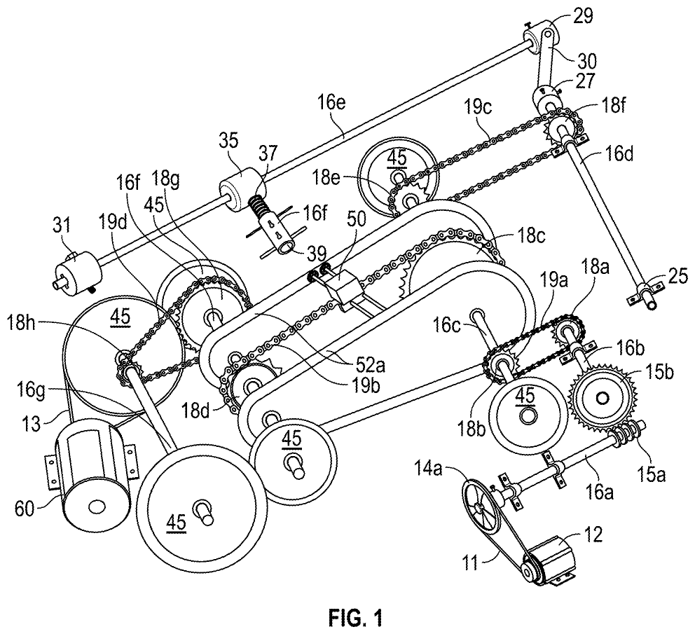

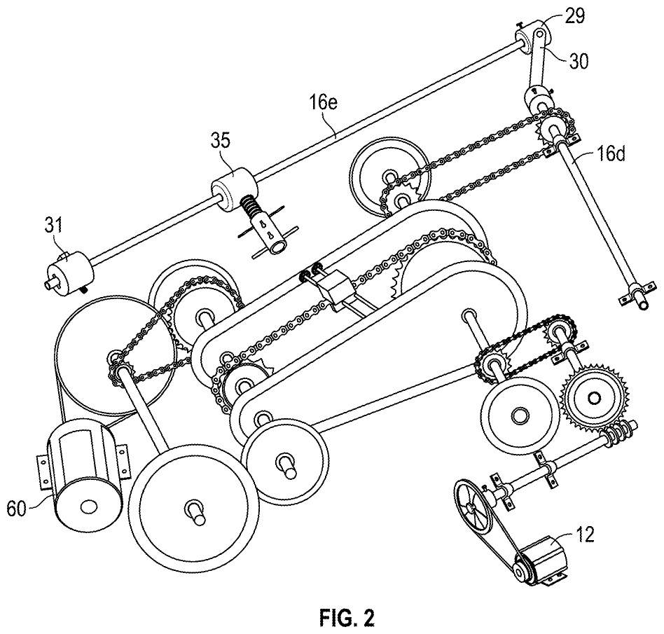

FIGS. 1, 2, 3, and 4 illustrate various schematic drawings of the system of this invention.

In at least an embodiment, input power being provided by means of a motor (12). Input power, according to a first non-limiting exemplary embodiment, can range from 1/15 HP to ¼ HP. The motor provides the requisite additional impetus to overcome, and compensate for, any frictional losses in this system that occur from input to output.

In at least an embodiment, a belt drive (11), from this motor (12), drives a communicably coupled first belt wheel (14a) which is coupled to a spaced apart worm and worm wheel (15a, 15b) by means of an angularly displaceable first shaft (16a); the first belt wheel (14a), the worm (15a), and worm wheel (15b) being synchronously angularly displaceable in relation to output of motor (12). RPM can be changed by changing belt wheel size of first belt wheel (14a) or ratio of worm and worm wheel (15a, 15b).

In at least an embodiment, a first toothed wheel (18a), located on a second shaft (16b), is connected, by means of a first chain drive (19a), to a second toothed wheel (18b), located on a third shaft (16c). The third shaft (16c) is spaced apart from the second shaft (16b). The first toothed wheel (18a) is, typically, a free wheel and ensures that it moves in a single direction only. The first toothed wheel (18a) is, in at least an embodiment, the same diameter as the second toothed wheel (18b).

In at least an embodiment, the second toothed wheel (18b) is located, axially, on the angularly displaceable third shaft (16c) and a third toothed wheel (18c) is located on the same angularly displaceable third shaft (16c). On the same angularly displaceable third shaft (16c), a fifth toothed wheel (18e) is located such that the second toothed wheel (18b) and the fifth toothed wheel (18e) are on either side of the third toothed wheel (18c); the second toothed wheel (18b), the fifth toothed wheel (18e), and the third toothed wheel (18c) are all co-axially located about the third shaft (16c).

In at least an embodiment, the third shaft (16c) connects the third toothed wheel (18c) to a fifth toothed wheel (18e); the second toothed wheel (18b), the fifth toothed wheel (18e), the third toothed wheel (18c), and the third shaft (16c) being synchronously angularly displaceable.

In at least an embodiment, a fourth toothed wheel (18d) is connected to the third toothed wheel (18c) by means of second chain drive (19b).The fourth toothed wheel (18d) has a specific correlation with the third toothed wheel (18c) in terms of number of teeth/diameters/radii/size. In a preferred embodiment, the ratio of the fourth toothed wheel (18d) to the third toothed wheel (18c), in terms of number of teeth/diameters/radii/size, is 1:2. In some other embodiments, this ratio can be 1:3, 1:4, 1:5, and so on and so forth. Basically, this increase in size from fourth toothed wheel (18d) to the third toothed wheel (18c) ensures a downward slope of the second chain drive (19b) from the third toothed wheel (18c) to the fourth toothed wheel (18d); this is very important to the working of this entire system because this slope ensures a gravity-fed mechanism which allows the system to harness gravity-fed kinetic energy of loads on the second chain drive (19b), as explained further.

The ratio, in terms of number of teeth/diameters/size, of the fourth toothed wheel (18d) to the third toothed wheel (18c) is 1:2, 1:3, 1:4, 1:5; this is according to the slope and length of the second chain drive (19b).

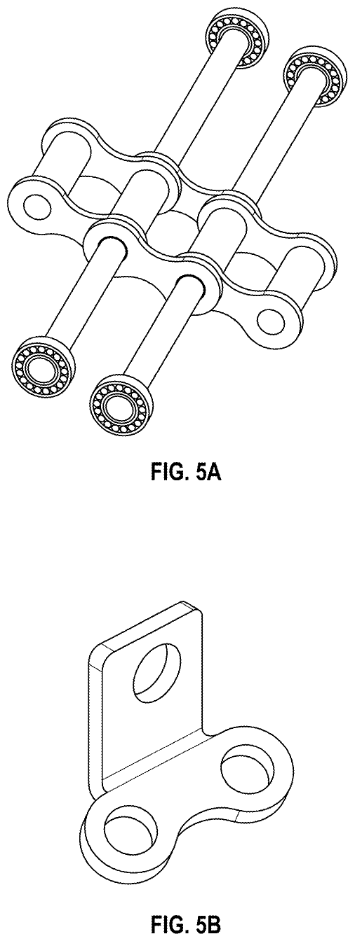

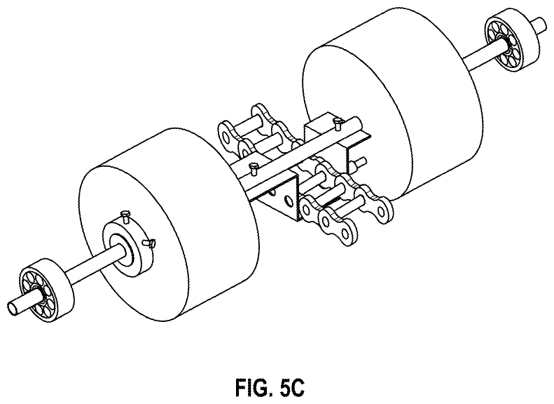

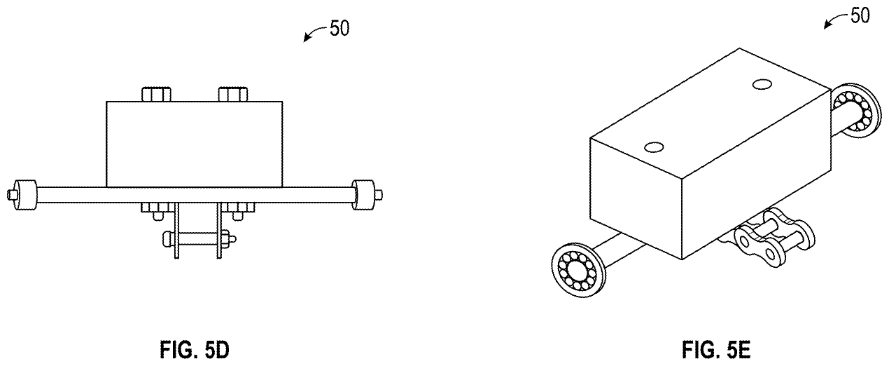

FIGS. 5A and 5B illustrate a schematic drawing of a load (50) and a load bracket (50a) associated with the load (50).

FIG. 5C illustrates a schematic drawing of another type of the same load (50).

FIGS. 5D and 5E illustrate a schematic drawing of another type of the same load (50).

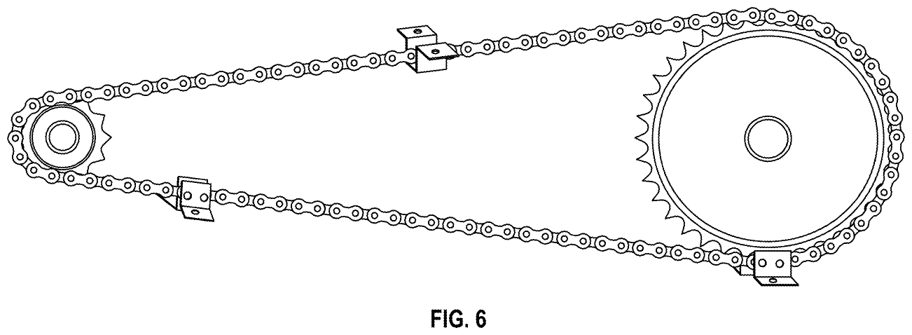

FIG. 6 illustrates a schematic drawing of loads (50) on the second chain drive (19b).

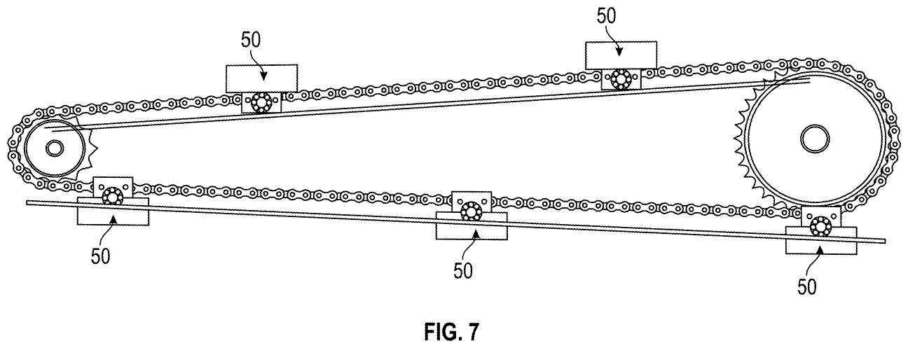

FIG. 7 illustrates another schematic drawing of loads (50) on the second chain drive (19b).

In at least an embodiment, there are a plurality of loads (50) installed on the second chain drive (19b). The number of these loads (50) can be 1, 2, 3, 4, 5, and so on and so forth; determined according to the teeth of the third toothed wheel drive (18c) and adjusted according to the fourth toothed wheel (18c).In at least an embodiment, a plurality of loads (50) are provided at pre-defined spaced apart intervals according to the teeth of the third toothed wheel (18c) on the second chain drive (19b). The loads (50) derive support from rails (52a, 52b) which run laterally spaced apart from the second chain drive (19b), on either side of the second chain drive (19b).

The slope of the second chain drive (19b), on its operative upper side, along with the weight of the load/s (50), is more than enough to induce kinetic energy into the load when it traverses the exit point (highest point where the second chain drive (19b) exits the third toothed wheel (18c)) of the second chain drive (19b) at the third toothed wheel (18c) up until it hits the entry point (engagement) of the second chain drive (19c) at the fourth toothed wheel (18d). This ‘induced’ kinetic energy is translated to further embodiments, discussed below, in this specification.

It is to be noted that number of loads (50) on the second chain drive (19b) is correlative to the slope achieved between the third toothed wheel (18c) and the fourth toothed wheel (18d); which is why number of loads (50), on the second chain drive (19b), is correlative to ratio of the fourth toothed wheel (18d) to the third toothed wheel (18c) in terms of number of teeth/diameters/radii/size, can be 1:2, 1:3, 1:4 or more.

According to preferred embodiments, if the ratio, in terms of number of teeth/diameters/radii/size, of the fourth toothed wheel (18d) to the third toothed wheel (18c) is 1:2, number of loads can be 1, 2, 3, 4, 5, or more.

According to preferred embodiments, if the ratio, in terms of number of teeth/diameters/radii/size, of the fourth toothed wheel (18d) to the third toothed wheel (18c) is 1:3, number of loads can be 1, 2, 3, 4, 5, or more.

According to preferred embodiments, if the ratio, in terms of number of teeth/diameters/radii/size, of the fourth toothed wheel (18d) to the third toothed wheel (18c) is 1:4, number of loads can be 1, 2, 3, 4, 5, or more.

In at least an embodiment, it is to be noted that ½ (number of teeth on the third toothed wheel (18c)=distance between two consecutive loads (50).

In at least an embodiment, a sixth toothed wheel (18f) is coupled to the fifth toothed wheel (18e) by means of a third chain drive (19c). The correlation, in terms of number of teeth/diameters/radii/size between the fifth toothed wheel (18e) and the sixth toothed wheel (18f), in preferred embodiments, is 1:1, as can be seen in FIG. 1.

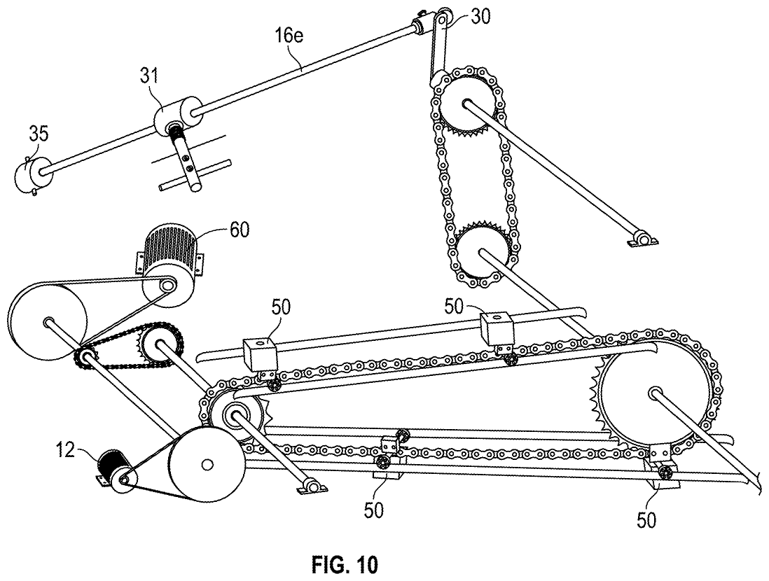

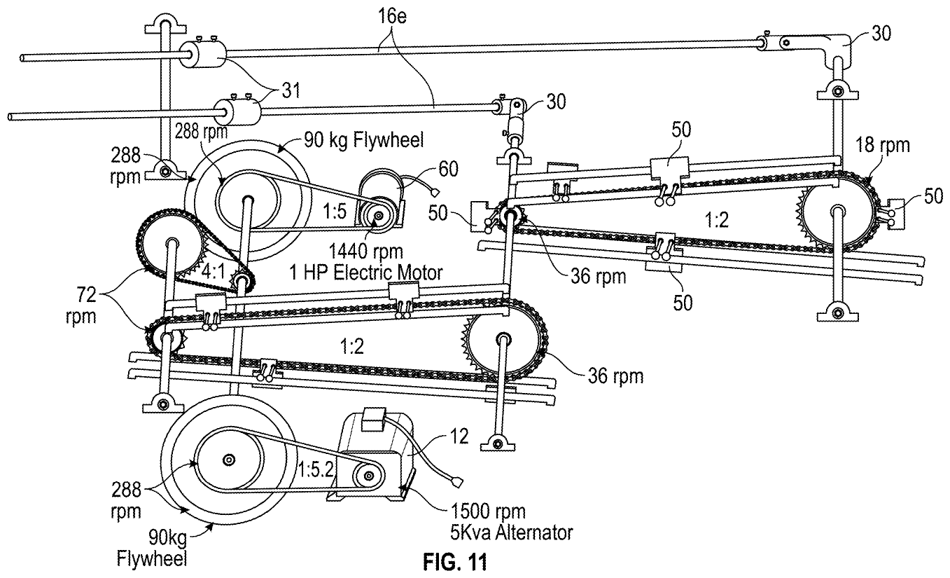

According to preferred embodiments, if the ratio, in terms of number of teeth/diameters/radii/size, of the fifth toothed wheel (18e) to the sixth toothed wheel (18f) is 1:1, number of loads can be 1, 2, 3, 4, 5 or more, as shown in FIG. 10.

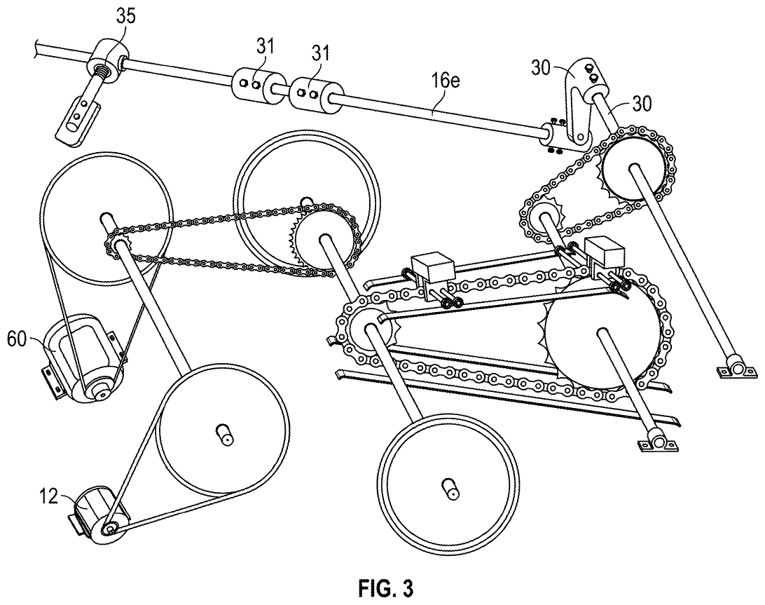

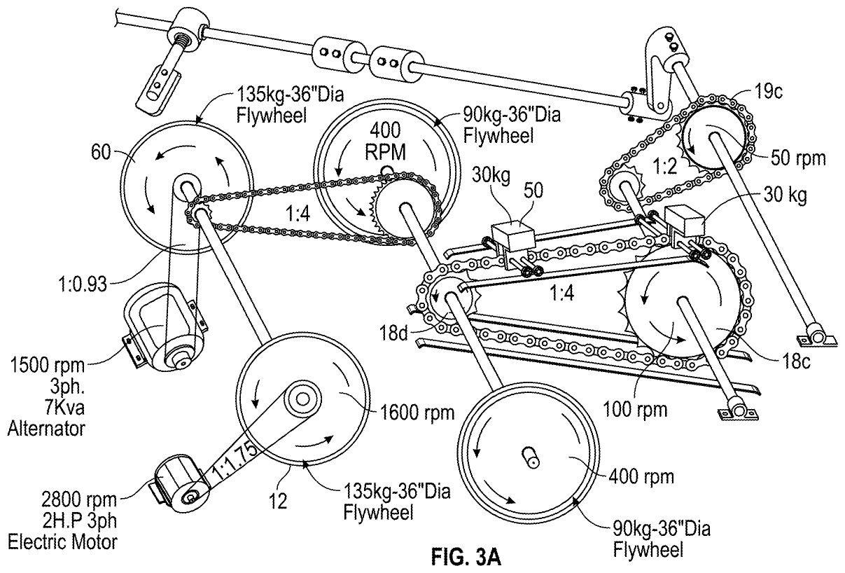

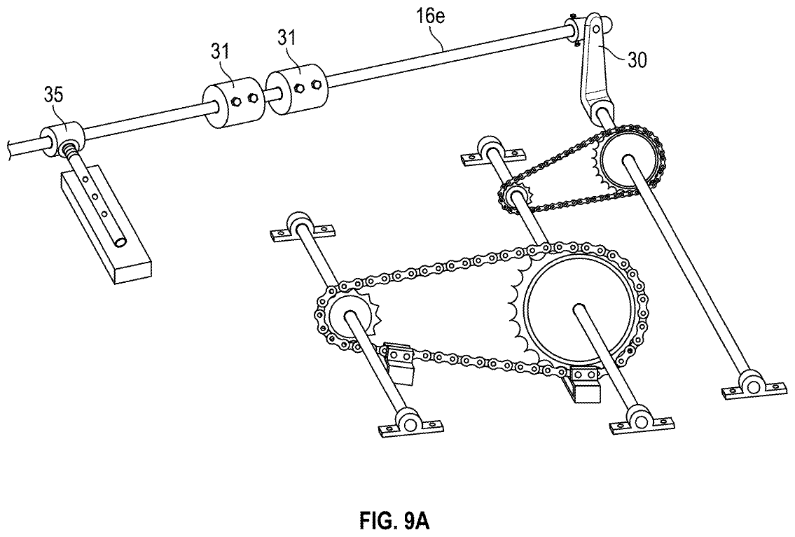

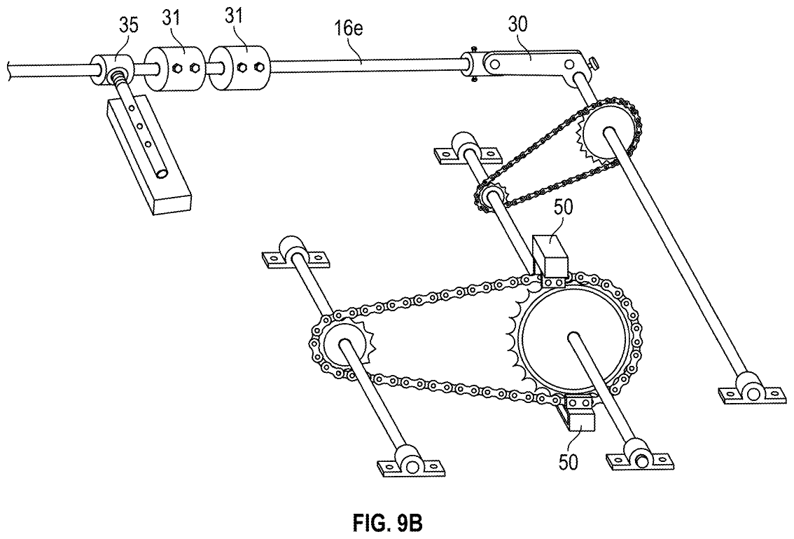

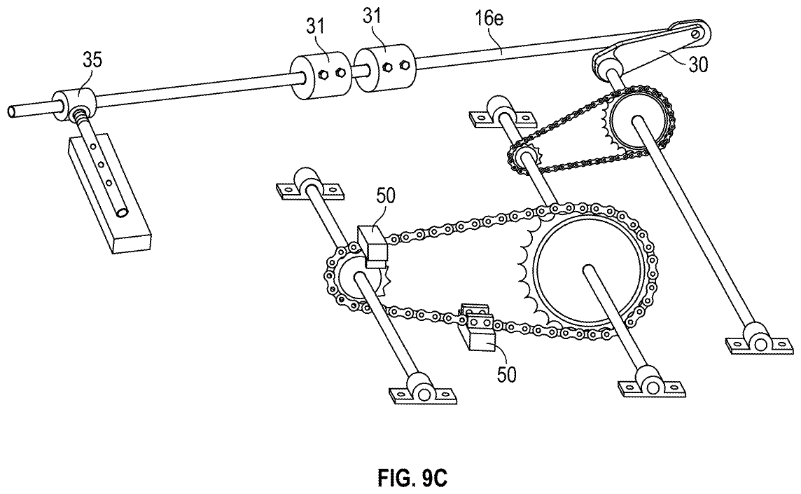

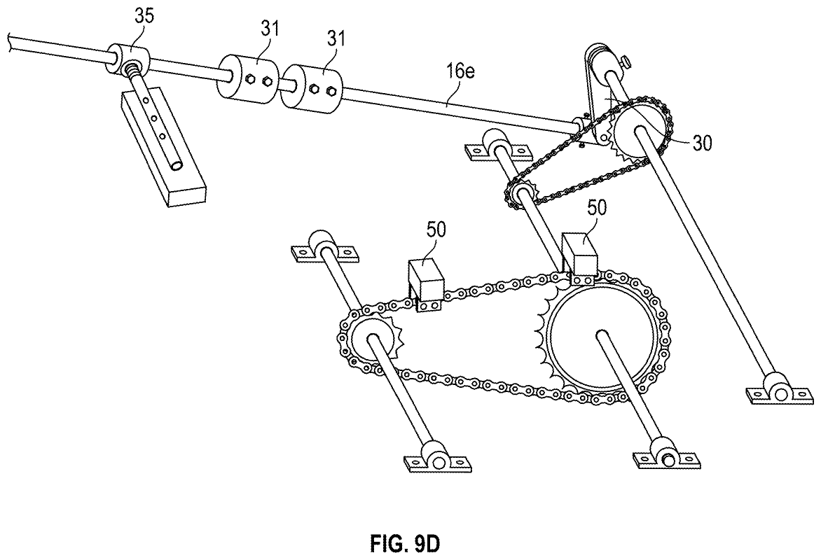

According to preferred embodiments, the ratio, in terms of number of teeth/diameters/radii/size, of the fifth toothed wheel (18e) to the sixth toothed wheel (18f) is 1:2, as shown in FIGS. 3, 9A, 9B, 9C, and 9D.

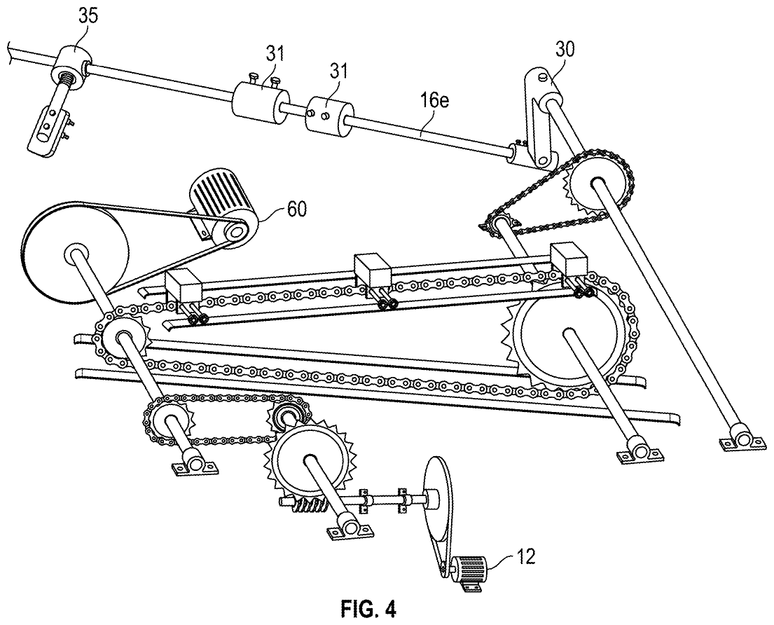

According to preferred embodiments, the ratio, in terms of number of teeth/diameters/radii/size, of the fifth toothed wheel (18e) to the sixth toothed wheel (18f) is 1:3, as shown in FIG. 4.

In at least an embodiment, a fourth shaft (16d) is provided about which the sixth toothed wheel (18f). A distal end (25), of this fourth shaft (16d), is fixed while a proximal end (27), of this fourth shaft (16d), is connected to an L-shaped lever (30), the distal end (29) of the L-shaped lever (30) is connected to a fifth shaft (16e); the short arm of the L-shaped lever (30) being co-axial with the fourth shaft (16d) and the long arm of the L-shaped lever (30) extending away and upwards from the short arm and being orthogonal to the fourth shaft (16d). Essentially, the L-shaped lever (30) forms a cam such that angular displacement of the sixth toothed wheel (18f) causes the proximal end (27), of the fourth shaft (16d), to be angularly displaced, in a first direction, only up to a first end point before reversing the direction to cause angular displacement, in a second direction, only up to a second end point, and so on and so forth, to form a rocking angular displacement motion, in a roll degree of freedom of a first plane, of a short arm of the L-shaped lever (30). This limited angular displacement in a first direction and a second direction is due to the fact that the distal end (25) of the fourth shaft (16d) is fixed and causes limitations to the range of angular displacement of the fourth shaft (16d) in any direction. Meanwhile, the long arm of the L-shaped lever (30), also causes rocking itself in terms of angular displacement, in a yaw degree of freedom of a second plane, orthogonal to the first plane. This rocking angular displacement causes the fifth shaft (16e) to be linearly displaceable about is length-wise axis; due to the cam action provisioned by the L-shaped lever (30).

This angular displacement of lever causes generation of a second force which is an extra force which allows the loads (50) to traverse a driver end (18c) of from where slope begins so that it can freeball along the slope to the driven end (18d); thereby, causing generation of a first force. The provisioning of rails (52a) ensures that the loads get a smoother ride which is gravity-fed and also that this extra force is captured. Thus, the load (31) causes the load (50) to be lifted up to a zenith of downward slope. When loads (50) are down, the shaft (16e) is forwardly displaced and upwardly displaced by the cam (30). When loads (50) are up, the shaft (16e) is backwardly displaced and downwardly displaced by the cam (30).

In preferred embodiments, the angular displacement, of the L-shaped lever (30), traverser 240 degrees i.e. 30 degrees beyond its highest point and 30 degrees beyond its lowest point. This extra traversal of 30 degrees, in either direction, provides the extra force required to ride up the loads (50) from their nadir point (at their point of engagement with the third toothed wheel (18c)) to their zenith point (at their point of disengagement with the third toothed wheel (18c)).

FIGS. 9A, 9B, 9C, and 9D show various positions of the L-shaped lever (30) along with corresponding location of loads (50) and corresponding location of auxiliary load (31).

In at least an embodiment, the fifth shaft (16e) has a proximal end (29) which connects to the L-shaped lever (30) and a distal end (31). An auxiliary load (60) can be provided at this fixed distal end (31) or at any point, in between, on the fifth shaft (16e).

Thus, the L-shaped lever (30) traverses 240 degrees for every load (50) present on the second chain drive (19b). When any load (50) is at the nadir point (at its point of engagement with the third toothed wheel (18c)), the proximal end (29) of the L-shaped lever (30) is 30 degrees beyond the positive 90 degrees (in a first quadrant) with respect to the axis of the fourth shaft (16d). When any load (50) is at the zenith point (at its point of disengagement with the third toothed wheel (18c)), the proximal end (29) of the L-shaped lever (30) is 30 degrees beyond the minus 90 degrees (in a fourth quadrant) with respect to the axis of the fourth shaft (16d).

In at least an embodiment, at some point, on the fifth shaft (16e), a slide bearing (35) is provided such that it ensconces the sixth shaft (16e) circumferentially through a hole in the slide bearing (35). A threaded sixth shaft (16f) with a fixed end (39) extends from the operative bottom of the slide bearing (35) such that the threadings (37), of the threaded sixth shaft (16f) form a coupling between the sixth threaded shaft (37) and the slide bearing (35). A linear displacement (forward-backward displacement) of the fifth threaded shaft (16e) causes the slide bearing (35) to angularly displace, alternatingly, between a first angular displacement direction and a second angular displacement direction to cause the threaded sixth shaft (16f) to also be angularly displaced about its linear length-wise axis. The ‘induced’ kinetic energy, from angular displacement of the slide bearing (35), is transferred to the loads (50) which is translated an output (60).

In at least an embodiment, the fourth toothed wheel (18d) is located, axially, about a sixth shaft (16f). About this sixth shaft, a seventh toothed wheel (18g) is also provided which, further, is connected by a fourth chain drive (19d) to an eighth toothed wheel (18h).

In at least an embodiment, the eighth toothed wheel (18h) is located, axially, about a seventh shaft (16g) from which output is, eventually, derived.

In at least an embodiment, an output generator (60) is coupled to the seventh shaft (16g) by means of a belt drive (13). The output (60) is more efficiently derived from the electrical input (12); this jump is achieved by harnessing the gravity fed kinetic energy of the loads (50, 31) and further induced/enunciated by actions of the slide bearing (35) and the L-shaped lever (30).

In at least an embodiment, input drive's shaft is the same as output drive's shaft.

Output power, according to the first non-limiting exemplary embodiment, can range from 2 to 5 times of input power.

Flywheels (45) are provided, in a balanced manner, at various locations, on various shafts.

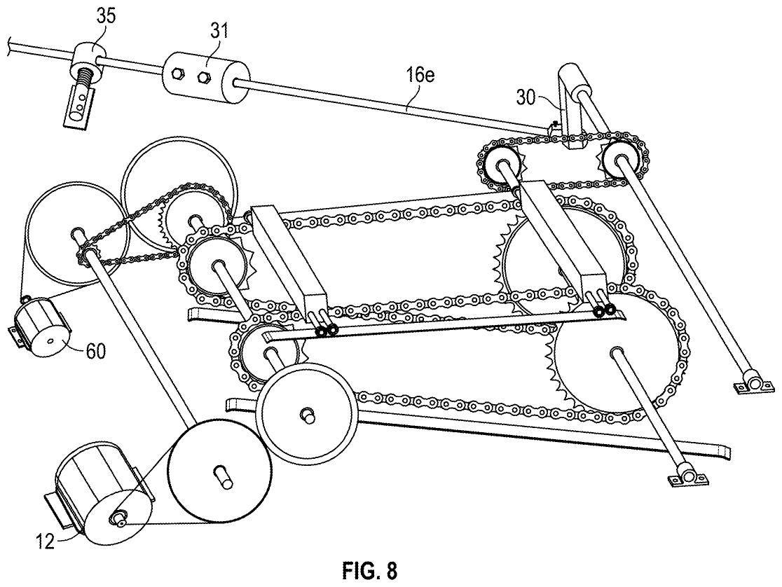

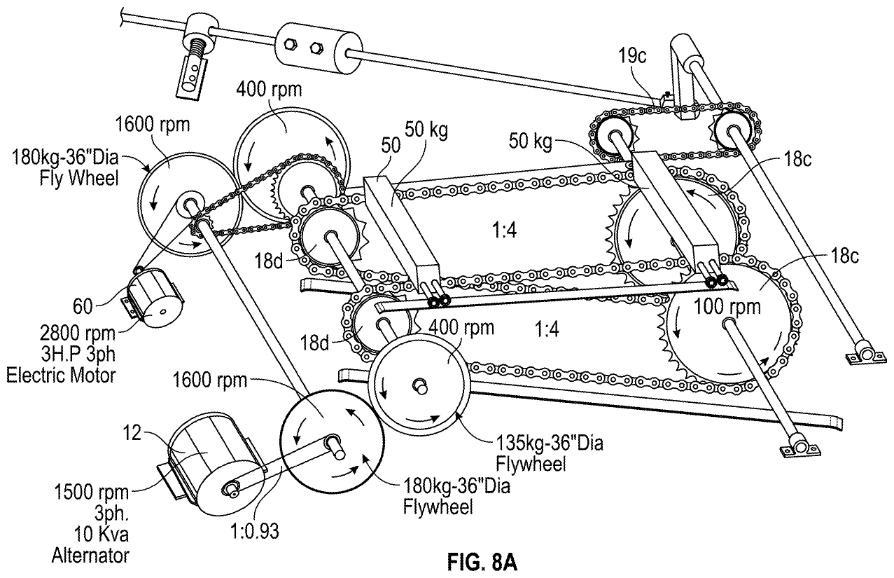

FIG. 8 illustrates another schematic drawing, depicting an alternative version, of the entire system.

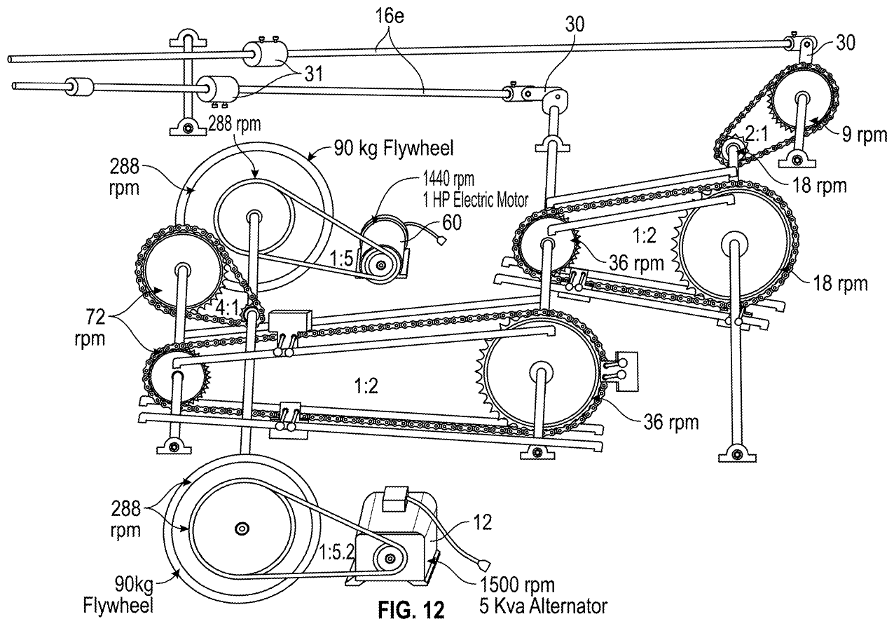

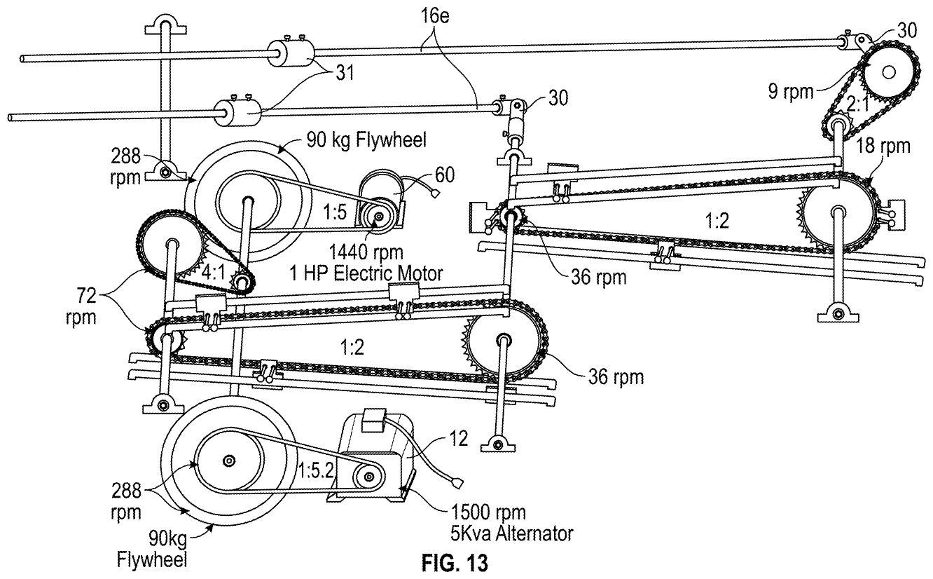

FIGS. 10, 11, 12, and 13 illustrate the system of this invention in relation to rpm of drives at various nodes in the system; and

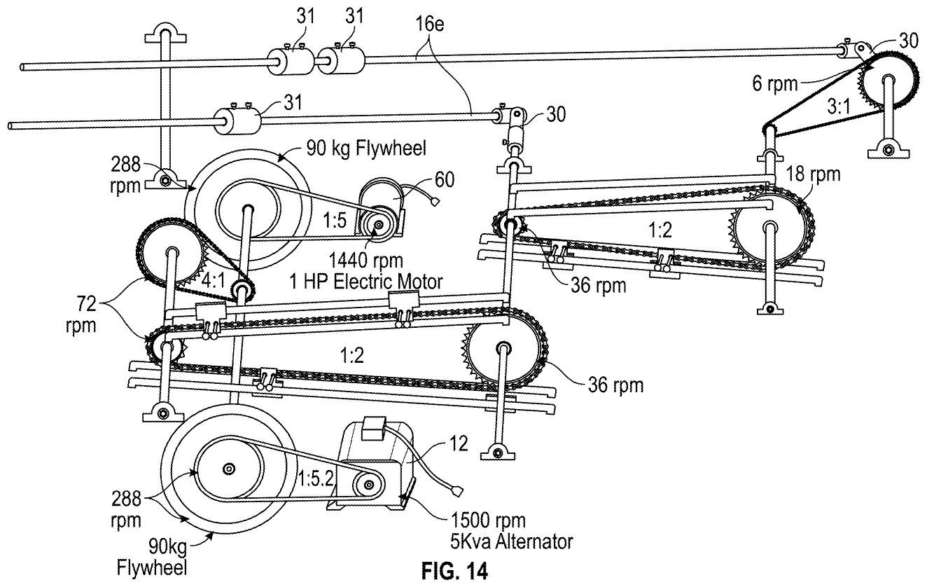

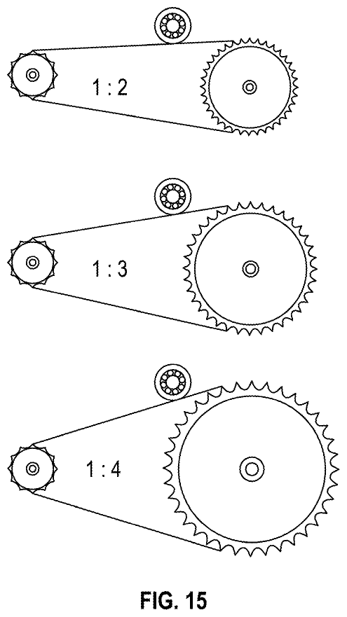

FIG. 14 illustrates how slope increases as ratio of driver end to driven end increases.

In terms of working,

1. The loads (50) moves to downward slope, it moves the third toothed wheel (18c) which is connected to the fifth toothed wheel (18e) through a third shaft (16c) and the fifth toothed wheel (18e) is connected to the sixth toothed wheel (18f) through a third chain drive (19c). The ratio of the fifth toothed wheel drive (18e) to sixth toothed wheel (18f) is 1:1. The sixth toothed wheel (18f) is connected to a fourth shaft (16d) which is connected to L-shaped lever (30). When the L-shaped lever (30) is in bottom position, at the same time loads (50a), in second chain wheel (21), moves to the downward slope. When the loads (50) moves downslope, it moves the third toothed wheel (18c) which is connected to the fifth toothed wheel (18e) through the third shaft (16c), at the same time fifth toothed wheel (18e) moves the sixth toothed wheel (18f) which is connected through a third chain drive (19c), and at the same time the sixth toothed wheel (18f) moves the L-shaped lever (30) to upward side, which is connected through the fourth shaft (16d). So, basically, loads (50) help the L-shaped lever (30) to move upward.

2. L-shaped lever (30) moves downward due to the load (31). The L-shaped lever (30) is connected to the load (31) through the long shaft (16e) via a slide bearing (35). The load (31) can be adjusted anywhere on the fifth shaft (16e) as per requirement. Due to the load (31), the L-shaped lever (30) moves downward rapidly through the slide bearing (35) which moves the fifth toothed wheel (18f) and the sixth toothed wheel (18e), which moves the third toothed wheel (18c), which helps the last load (50) on the second chain drive (19b) to step-up or move upward to an upper position of the third toothed wheel (18c). Basically, in this, the load (31) helps the load (50) to move upward.

According to a first non-limiting exemplary embodiment, FIG. 3A illustrates a complete working embodiment where:
Input (12) is angularly displacing at 2800 rpm, 3 phase, 2 HP electric motor connected in a ratio of 1:1.75 to a 135 kg, 36″ diameter flywheel which angularly displaces at 1600 rpm which angularly displaces another flywheel at 400 rpm;
load (50) is 30 kg;
fourth toothed wheel (18d) is angularly displacing at 400 rpm and third toothed wheel (18c) is angularly displacing at 100 rpm;
third toothed wheel (18c) is connected to 18d in a ratio of 1:4;
second chain drive (19c) is in the ratio of 1:2;
output (60) is angularly displacing at 1500 rpm, 7 kVa Alternator, 3 phase connected in a ratio of 1:0.93 to a 180 kg, 36″ diameter flywheel which angularly displaces at 1600 rpm.

According to a second non-limiting exemplary embodiment, FIG. 8A illustrates a complete working embodiment where:
Input (11) is angularly displacing at 2800 rpm, 3 phase, 3 HP, electric motor connected in a ratio of 1:1.75 to a 180 kg, 36″ diameter flywheel which angularly displaces at 1600 rpm which angularly displaces another flywheel at 400 rpm;
load (50) is 50 kg;
fourth toothed wheel (18d) is angularly displacing ar 400 rpm and third toothed wheel (18c) is angularly displacing at 100 rpm;
second chain drive (19c) is in the ratio of 1:1;
output (60) is angularly displacing at 1500 rpm, 10 kVa Alternator, 3 phase connected in a ratio of 1:0.93 to a 180 kg, 36″ diameter flywheel which angularly displaces at 1600 rpm.

The TECHNICAL ADVANCEMENT of this invention lies in inducing gravity-fed kinetic energy via loads, located on a sloped drive, and via loads which cause slide-bearings to angularly displace levers beyond their stipulated degree of angular displacement; thereby causing the extra thrust of kinetic energy which can be translated into electrical energy.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A load-driven energy system comprising:
a motor;
an input drive configured to transfer power from the motor to further drives as input drive power;
a load-bearing drive bearing loads and configured to receive the input drive power at a driver end and transfer the input drive power to drive the loads across the load-bearing drive, wherein the load bearing drive has a downward slope from the driver end to a driven end;
rails laterally spaced apart from the load bearing drive and configured to drive the loads under a force of gravity;
a supporting drive coupled with the load bearing drive and including a shaft and cam, wherein the cam is configured to convert angular displacement from the input drive power to linear displacement of the shaft to drive the loads under a force of the linear displacement of the shat; and
an alternator connected to the load-bearing drive to output load-driven power.

2. The system of claim 1, wherein the input drive includes,
a first drive, from the motor, configured to angularly displace a first angularly displaceable shaft,
a first toothed wheel located on a second angularly displaceable shaft, wherein the second angularly displaceable shaft is transverse to the first angularly displaceable shaft,
a second drive from a second toothed wheel coupled to the first toothed wheel by a second drive, wherein the second toothed wheel is located on a third angularly displaceable shaft laterally spaced apart from the second angularly displaceable shaft,
a third toothed wheel being located on the third angularly displaceable shaft,
a fourth toothed wheel connected to the third toothed wheel by a third drive, wherein a radius of the fourth toothed wheel is greater than a radius of the third toothed wheel so as to cause a downward slope of the second drive from the third toothed wheel to the fourth toothed wheel to harness gravity-fed kinetic energy of loads on the third drive, and
a fifth toothed wheel located on the third angularly displaceable shaft,
wherein the load bearing drive includes,
a plurality of loads installed on the third drive, wherein a number of the loads is correlative to a number of teeth of the third toothed wheel and adjusted according to the fourth toothed wheel, wherein the number of the loads is correlative to a slope achieved between the third toothed wheel and the fourth toothed wheel, and
a sixth toothed wheel coupled to the fifth toothed wheel by a fourth drive,
wherein the load supporting drive includes,
a fourth angularly displaceable shaft configured to host the sixth toothed wheel, wherein a distal end of the fourth angularly displaceable shaft is fixed while a proximal end of the fourth angularly displaceable shaft is connected to an L-shaped lever, wherein the distal end of the L-shaped lever is connected to a fifth angularly displaceable shaft, wherein a short arm of the L-shaped lever is co-axial with the fourth angularly displaceable shaft and a long arm of the L-shaped lever extending away and upwards from the short arm and being orthogonal to the fourth angularly displaceable shaft, and
a slide bearing provided at a point on the fifth angularly displaceable shaft, wherein the slide ensconces the sixth shaft circumferentially through a hole in the slide bearing,
wherein the output drive includes,
a sixth angularly displaceable shaft with a fixed end extending from a bottom of the slide bearing so that threadings of the sixth angularly displaceable shaft form a coupling between a threaded shaft and the slide bearing,
a seventh toothed wheel connected by a fourth drive to an eighth toothed wheel, and
an eighth toothed wheel located axially about a seventh angularly displaceable shaft from which output is derived.

3. The system of claim 2, wherein the first drive is a belt drive configured to drive a communicably coupled first belt wheel coupled to a spaced-apart worm and worm wheel by the first angularly displaceable first shaft, and wherein the first belt wheel, the worm, and the worm wheel are synchronously angularly displaceable in relation to output of the motor.

4. The system of claim 2, wherein the first toothed wheel is connected by the second drive to a second toothed wheel located on the third shaft, wherein being the second drive is a first chain drive, wherein the third shaft is spaced apart from the second shaft, and wherein the first toothed wheel is a free wheel ensuring that it moves in a single direction only.

5. The system of claim 2, wherein the first toothed wheel is the same diameter as the second toothed wheel.

6. The system of claim 2, wherein the second toothed wheel is located axially on the angularly displaceable third shaft and the third toothed wheel is located on the angularly displaceable third shaft.

7. The system of claim 2, wherein the fifth toothed wheel is located on the third angularly displaceable shaft such that the second toothed wheel and the fifth toothed wheel are on either side of the third toothed wheel, and wherein the second toothed wheel, the fifth toothed wheel, and the third toothed wheel are all co-axially located about the third angularly displaceable shaft.

8. The system of claim 2, wherein the third angularly displaceable shaft connects the third toothed wheel to the fifth toothed wheel, and wherein the second toothed wheel, the fifth toothed wheel, the third toothed wheel, and the third shaft are synchronously angularly displaceable.

9. The system of claim 2, wherein the fourth toothed wheel is connected to the third toothed wheel by the second drive.

10. The system of claim 2, wherein the fourth toothed wheel has a 1:2-5 ratio with the third toothed wheel in terms of number of teeth, diameters, radii, or size.

11. The system of claim 2, wherein the loads are supported from the rails running laterally spaced apart from the third drive, on sides of the second drive.

12. The system of claim 2, wherein half the number of teeth on the third toothed wheel equals a distance between two consecutive loads.

13. The system of claim 2, wherein a ratio, in terms of number of teeth, diameters, radii, or size between the fifth toothed wheel and the sixth toothed wheel is 1:1.

14. The system of claim 2, wherein,
the L-shaped lever forms a cam such that angular displacement of the sixth toothed wheel causes the proximal end of the fourth angularly displaceable shaft to be angularly displaced in a first direction only up to a first end point before reversing the direction to cause angular displacement in a second direction only up to a second end point to form a rocking angular displacement motion, in a roll degree of freedom of a first plane, of a short arm of the L-shaped lever,
the long arm of the L-shaped lever causes rocking itself in terms of angular displacement in a yaw degree of freedom of a second plane, orthogonal to the first plane, wherein the rocking angular displacement causes the fifth shaft to be linearly displaceable about is length-wise axis due to the cam action caused by the L-shaped lever.

15. The system of claim 2, wherein the angular displacement of the L-shaped lever traverses 240 degrees which is 30 degrees beyond its highest point and 30 degrees beyond its lowest point, the extra traversal of 30 degrees, in either direction, provides extra force required to ride up the loads from their nadir point at their point of engagement with the third toothed wheel to their zenith point at their point of disengagement with the third toothed wheel.

16. The system of claim 2, wherein the fifth angularly displaceable shaft has a proximal end connected to the L-shaped lever and a distal end that is an auxiliary load.

17. The system of claim 2, wherein a sixth angularly displaceable shaft with a fixed end extends from an operative bottom of the slide bearing such that threadings of the threaded sixth angularly displaceable shaft forms a coupling between the sixth threaded shaft and the slide bearing.

18. The system of claim 2, wherein the fourth toothed wheel is located axially about the sixth angularly displaceable shaft.

19. The system of claim 2 wherein, the output generator is coupled to the seventh shaft by a belt drive.

20. The system of claim 2 wherein, the input drive's shaft is the same as the output drive's shaft.
